(19) United States
(12) Patent Application Publication
(10) Pub. No.: US 2016/0227123 A1
(43) Pub. Date: Aug. 4, 2016

(54) MIRROR CONTROL DEVICE AND MIRROR CONTROL SYSTEM

(71) Applicant: KABUSHIKI KAISHA TOKAI RIKA DENKI SEISAKUSHO, Aichi (JP)

(72) Inventors: Tatsuya NAGASE, Aichi (JP); Shinichi MIYAZAKI, Aichi (JP)

(21) Appl. No.: 15/012,153

(22) Filed: Feb. 1, 2016

(30) Foreign Application Priority Data
Feb. 2, 2015 (JP) 2015-018435

(51) Int. Cl. H04N 5/232; G06T 3/40; G06F 3/041

(52) U.S. Cl. CPC H04N 5/23293; G06F 3/041; G06T 3/40

(57) ABSTRACT

A mirror control device includes a touchpad that is mounted on a vehicle and detects an operation performed on an operation surface, and a control unit that controls at least one of an optical mirror device and an electronic mirror device mounted on the vehicle based on an operation detected by the touchpad and adjusts an image around the vehicle to be visually checked by an operator through the optical mirror device and/or the electronic mirror device. A mirror control system includes the touchpad, at least one of the optical mirror device and the electronic mirror device mounted on the vehicle, and the control unit.

The present application is based on Japanese patent application No. 2015-018435 filed on Feb. 2, 2015, the entire contents of which are incorporated herein by reference.

### BACKGROUND OF THE INVENTION

1. Field of the Invention

The invention relates to a mirror control device and a mirror control system.

2. Related Art

A door mirror switch is known which is configured as a rocker switch capable of detecting a push operation using a push switch detecting a push operation and a joystick switch detecting a multi-directional input in at least four directions (see e.g., JP-A-2009-154777).

The door mirror switch can adjust a door mirror which is selected by an adjacently arranged selector switch.

### SUMMARY OF THE INVENTION

The door mirror switch allows only the multi-directional input and the push operation. Thus, if an electronic mirror is used so as to zoom in or out an image around a vehicle, it needs to be equipped with other switch therefor.

It is an object of the invention to provide a mirror control device and a mirror control system that are flexibly adapted to mirror devices with different functions.

(1) According to an embodiment of the invention, a mirror control device comprises:

a touchpad that is mounted on a vehicle and detects an operation performed on an operation surface; and

a control unit that controls at least one of an optical mirror device and an electronic minor device mounted on the vehicle based on an operation detected by the touchpad and adjusts an image around the vehicle to be visually checked by an operator through the optical mirror device and/or the electronic mirror device.

(2) According to another embodiment of the invention, a mirror control system comprises:

a touchpad that is mounted on a vehicle and detects an operation performed on an operation surface;

at least one of an optical mirror device and an electronic mirror device mounted on the vehicle; and

a control unit that controls the optical mirror device and/or the electronic mirror device based on an operation detected by the touchpad and adjusts an image around the vehicle to be visually checked by an operator through the optical mirror device and/or the electronic mirror device.

### Effects of the Invention

According to an embodiment of the invention, a mirror control device and a mirror control system can be provided that are flexibly adapted to mirror devices with different functions.

### BRIEF DESCRIPTION OF THE DRAWINGS

Next, the present invention will be explained in more detail in conjunction with appended drawings, wherein:

FIG. 1A is an illustration diagram showing a vehicle mounting a mirror control device in a first embodiment when viewed from the rear side of the vehicle;

FIG. 1B is an illustration diagram showing an example of a steering wheel area in which the mirror control device is arranged;

FIG. 1C is a block diagram showing a configuration example of a minor control system including the mirror control device;

FIG. 2A is an illustration diagram showing an example of the mirror control device in the first embodiment;

FIG. 2B is an illustration diagram showing an example of a relation between operation objects and functions of the mirror control device;

FIG. 3 is a flowchart showing an example operation of the mirror control device in the first embodiment;

FIG. 4A is an illustration diagram showing a vehicle mounting a mirror control device in a second embodiment when viewed from the rear side of the vehicle;

FIG. 4B is an illustration diagram showing an example of a steering wheel area in which the mirror control device is arranged; and

FIG. 5A is a block diagram showing a configuration example of a mirror control system including the mirror control device in the second embodiment; and

FIG. 5B is an illustration diagram showing an example of a relation between operation objects and functions of the mirror control device.

### DETAILED DESCRIPTION OF THE PREFERRED EMBODIMENTS

### Summary of the Embodiments

Minor control devices in the embodiments are generally composed of a touchpad that is mounted on a vehicle and detects an operation performed on an operation surface, and a control unit that controls mirror devices mounted on the vehicle based on the operation detected by the touchpad and adjusts an image around the vehicle to be visually checked by an operator through the mirror devices, the mirror devices being at least either optical mirror devices or electronic mirror devices.

### First Embodiment

Configuration of Mirror Control Device 1

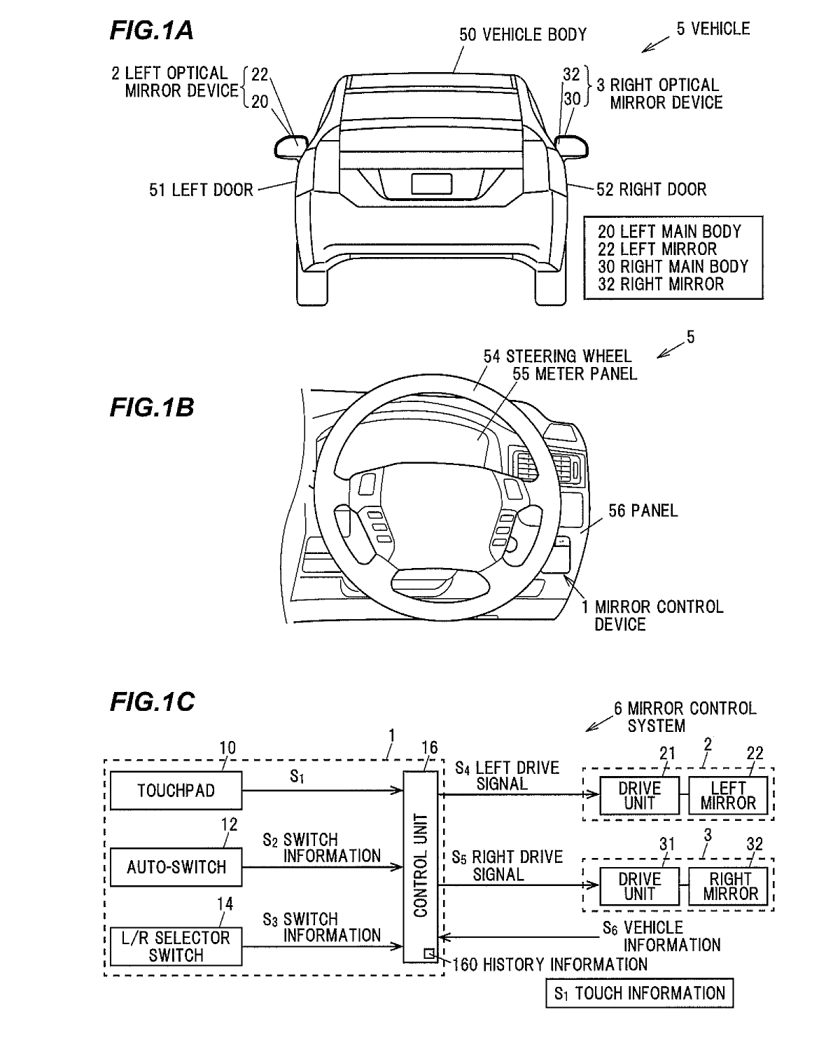

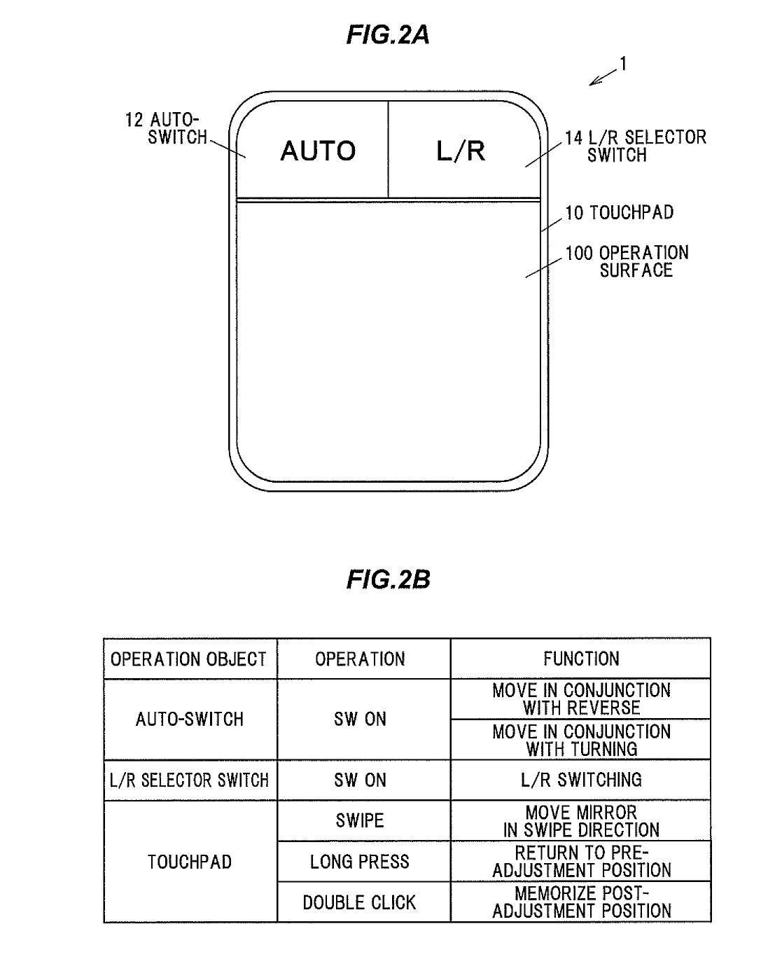

FIG. 1A is an illustration diagram showing a vehicle mounting a mirror control device in the first embodiment when viewed from the rear side of the vehicle, FIG. 1B is an illustration diagram showing an example of a steering wheel area in which the mirror control device is arranged, and FIG. 1C is a block diagram showing a configuration example of a mirror control system including the mirror control device. FIG. 2A is an illustration diagram showing an example of the mirror control device in the first embodiment and FIG. 2B is an illustration diagram showing an example of a relation between operation objects and functions of the mirror control device. “SW ON” shown in FIG. 2B means that a switch is in the on state.

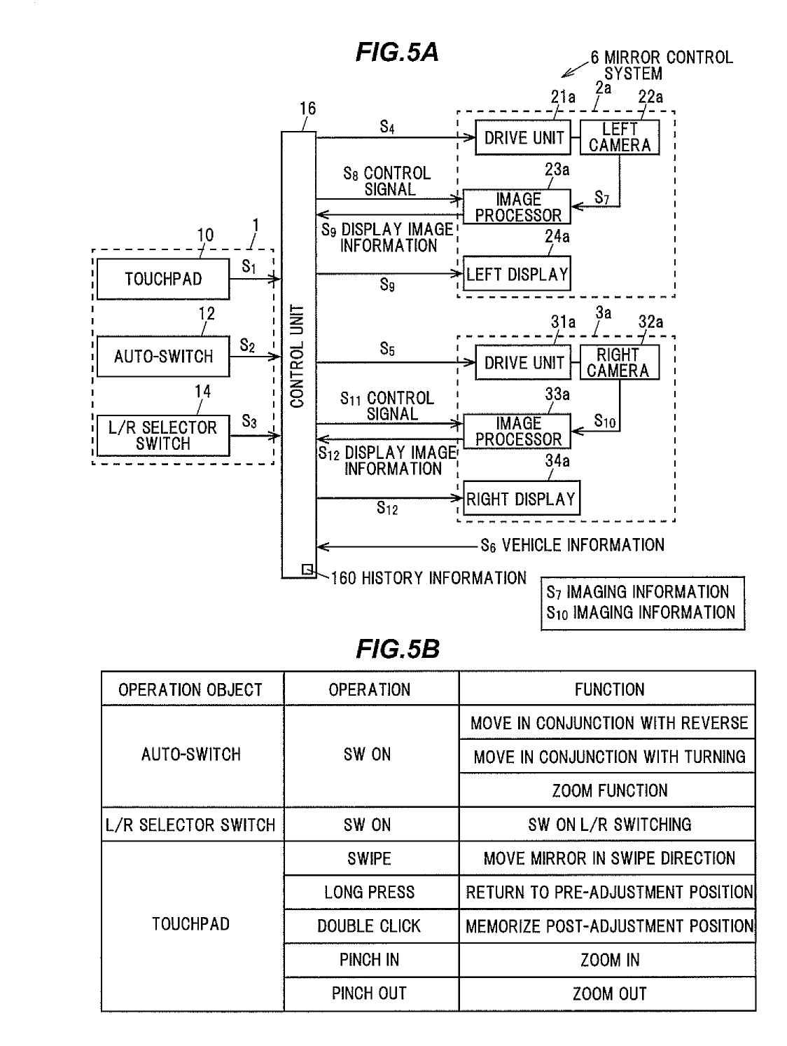

A scale ratio in each drawing of the embodiments may be different from the actual scale ratio. In addition, in FIG. 1C and FIG. 5A (described later), flows of main signals and information are indicated by arrows. “Right” and “left” herein mean right and left of an operator sitting on the driver's seat of a vehicle 5. “Front” is the front of the operator and “rear” is backward. In addition, the vehicle 5 is a right-hand drive vehicle in which a steering wheel 54 is located in front of the operator sitting on the right seat.

The mirror control device 1 in the first embodiment is configured to control optical mirror devices. The optical mirror device is to produce an image of the rear side of the vehicle 5 on a mirror surface using reflection of light. The mirror control device 1 can adjust an angle of the mirror surface.

In detail, as shown in FIGS. 1A and 1B, the minor control device 1 is configured to be able to adjust angles of a left mirror 22 of a left optical mirror device 2 and a right mirror 32 of a right optical minor device 3 which are arranged on the exterior of a vehicle body 50 of the vehicle 5. The left optical mirror device 2 is arranged on a left door 51 of the vehicle 5 and the right optical mirror device 3 is arranged on a right door 52.

The mirror control device 1 is arranged on, e.g., a panel 56 on the lower right side of the steering wheel 54, as shown in FIG. 1B. Alternatively, the mirror control device 1 may be arranged on, e.g., the interior side of the right door 52 or another position.

As shown in FIGS. 1C and 2A, the mirror control device 1 is generally composed of a touchpad 10 which is mounted on the vehicle 5 and detects an operation performed on an operation surface 100, and a control unit 16 which controls the left optical minor device 2 and the right optical mirror device 3 as the optical mirror devices mounted on the vehicle 5 based on the operation detected by the touchpad 10 and adjusts an image around the vehicle 5 to be visually checked by an operator through the left optical minor device 2 and the right optical mirror device 3.

The control unit 16 generates and stores history information 160 as a history of adjustment, retrieves the history information 160 based on a predetermined operation performed on the touchpad 10 and restores the pre-adjustment state.

The mirror control device 1 is provided with, e.g., an auto-switch 12 and an L/R selector switch 14, as shown in FIGS. 1C and 2A.

Configuration of Left Optical Mirror Device 2

The left optical mirror device 2 is generally composed of, e.g., a left main body 20, a drive unit 21 and the left mirror 22, as shown in FIGS. 1A and 1C.

The drive unit 21 is provided with, e.g., a motor and a gear portion for transmitting rotation of the motor to the left mirror 22. The motor is configure to rotate forward and reverse based on a left drive signal S₄ (described later).

The left mirror 22 is configured to rotate in vertical and horizontal directions relative to the left main body 20, as viewed in the plane of FIG. 1A. In the following description, in case of horizontal rotation, counterclockwise rotation means rotation which causes a side portion of the left mirror 22 on the vehicle body 50 side to enter the left main body 20. Meanwhile, in case of vertical rotation, clockwise rotation means rotation which causes the upper side of the left mirror 22 to enter the left main body 20. The vertical and horizontal rotation allows the left mirror 22 to be adjusted to any angle with respect to the left main body 20 within an acceptable range.

Configuration of Right Optical Mirror Device 3

The right optical mirror device 3 is generally composed of, e.g., a right main body 30, a drive unit 31 and the right mirror 32, as shown in FIGS. 1A and 1C.

The drive unit 31 is provided with, e.g., a motor and a gear portion for transmitting rotation of the motor to the right mirror 32. The motor is configure to rotate forward and reverse based on a right drive signal S₅ (described later).

The right mirror 32 is configured to rotate in vertical and horizontal directions relative to the right main body 30, as viewed in the plane of FIG. 1A. In the following description, in case of horizontal rotation, clockwise rotation means rotation which causes a side portion of the right mirror 32 on the vehicle body 50 side to enter the right main body 30. Meanwhile, in case of vertical rotation, counterclockwise rotation means rotation which causes the upper side of the right mirror 32 to enter the right main body 30. The vertical and horizontal rotation allows the right mirror 32 to be adjusted to any angle with respect to the right main body 30 within an acceptable range.

Configuration of Touchpad 10

The touchpad 10 is a touch sensor which detects a position on the operation surface 100 touched by, e.g., a portion of the body of an operator (e.g., a finger) or a special pen. As the touchpad 10, it is possible to use, e.g., resistive, infrared, SAW (Surface Acoustic Wave), and capacitive touch sensors, etc. The touchpad 10 in the first embodiment is, e.g., a capacitive multi-touch sensor. In the following description, an operation by an operator's finger (an operating finger) will be explained.

The touchpad 10 generates touch information S₁ corresponding to the operation performed on the operation surface 100 and outputs the touch information S₁ to the control unit 16. The touch information S₁ is periodically generated. The touchpad 10 also can detect, e.g., a swipe operation, a long press operation, a double click operation, a tap operation, a pinch-in operation and a pinch-out operation, etc.

The swipe operation is an operation performed by bringing an operating finger into contact with the operation surface 100 and then sliding the operating finger in one direction while keeping the contact with the operation surface 100. The long press operation is an operation performed by keeping a contact of the operation finger with the operation surface 100 for not less than a predetermined period of time. The double click operation is an operation performed by tapping the operation surface 100 twice by the operating finger. The tap operation is an operation performed by tapping the operation surface 100 once by the operating finger. The pinch-in operation is an operation performed by bringing two operating fingers into contact with the operation surface 100 and then pinching the two operating fingers together while keeping the contact with the operation surface 100. The pinch-out operation is an operation performed by bringing two operating fingers into contact with the operation surface 100 and then spreading the two operating fingers apart while keeping the contact with the operation surface 100.

Configuration of Auto-Switch 12

The auto-switch 12 is a switch to adjust mirrors according to the traveling direction of the vehicle 5. The auto-switch 12 is arranged at the upper left of the touchpad 10, as viewed in the plane of FIG. 2A. In addition, the auto-switch 12 is configured as, e.g., a push momentary switch which can be push-operated. The auto-switch 12 generates switch information S₂ in response to the push operation and outputs the switch information S₂ to the control unit 16.

Configuration of L/R Selector Switch 14

The L/R selector switch 14 is a switch to select an optical mirror device to be adjusted. The L/R selector switch 14 is arranged at the upper right of the touchpad 10, as viewed in the plane of FIG. 2A. The L/R selector switch 14 is configured as, e.g., a push momentary switch which can be push-operated. The L/R selector switch 14 generates switch information S₃ in response to the push operation and outputs the switch information S₃ to the control unit 16.

Configuration of Control Unit 16

The control unit 16 is, e.g., a microcomputer composed of a CPU (Central Processing Unit) performing calculation and processing, etc., of the acquired data according to a stored program, a RAM (Random Access Memory) and a ROM (Read Only Memory) which are semiconductor memories. The ROM stores, e.g., a program for operation of the control unit 16. The RAM is used as, e.g., a storage area for temporarily storing calculation results, etc., and is also configured to store the history of mirror position in chronological order as the history information 160.

The control unit 16 generates the left drive signal S₄ or the right drive signal S₅ based on the acquired touch information S₁, switch information S₂ and switch information S₃. The control unit 16 generates the left drive signal S₄ also based on vehicle information S₆ when the auto-switch 12 is in the on state.

The vehicle information S₆ is output from, e.g., a vehicle control unit of the vehicle 5 and is information associated with at least the traveling direction and speed of the vehicle 5.

Functions Which Can Be Instructed By Mirror Control Device 1

The Case Where the Operation Object is the Touchpad 10

When the operation object is the touchpad 10, the mirror control device 1 executes different functions depending on the swipe operation, the long press operation and the double click operation, as shown in FIG. 2B.

When it is determined, based on the touch information S₁ acquired from the touchpad 10, that the swipe operation is performed, the control unit 16 moves a mirror in the swipe direction. When it is determined that the swipe operation is performed from, e.g., left to right as viewed in the plane of FIG. 2A, the control unit 16 outputs the left drive signal S₄, when the left mirror 22 is selected, to rotate the left mirror 22 counterclockwise in the horizontal direction, or the right drive signal S₅, when the right mirror 32 is selected, to rotate the right mirror 32 counterclockwise in the horizontal direction.

Meanwhile, when the swipe operation is performed, e.g., from top to bottom as viewed in the plane of FIG. 2A, the control unit 16 outputs the left drive signal S₄, when the left mirror 22 is selected, to rotate the left mirror 22 counterclockwise in the vertical direction, or the right drive signal S₅, when the right mirror 32 is selected, to rotate the right mirror 32 clockwise in the vertical direction. The rotation amount depends on a swipe distance.

Furthermore, when the swipe operation is performed, e.g., diagonally as viewed in the plane of FIG. 2A, the control unit 16 resolves a trace of the swipe operation into a horizontal component and a vertical component and rotates the selected mirror according to each component.

When it is determined, based on the touch information S₁, that the long press operation is performed, the control unit 16 moves the adjusted mirror back to the pre-adjustment position (state). The control unit 16 controls the mirror to move back to the pre-adjustment position based on, e.g., the history information 160. The predetermined operation mentioned previously is the long press operation.

In addition, when it is determined, based on the touch information S₁, that the double click operation is performed, the control unit 16 memorizes the mirror position, which is an object to be adjusted, as the history information 160.

The Case Where the Operation Object is the Auto-Switch 12

When the auto-switch 12 is the operation object and is in the on state, the control unit 16 executes functions to move the mirrors in conjunction with reverse or turning based on the vehicle information S₆ acquired from the vehicle 5.

The motion in conjunction with reverse is a function to move the left mirror 22 when the control unit 16 determines based on the vehicle information S₆ that the vehicle 5 is moving backward, so that the left mirror 22 produces the image around the left rear wheel which is hard to see from the operator's position. Then, when it is determined that the backward movement is finished, the control unit 16 moves the left mirror 22 back to the pre-movement position. Furthermore, when the operator repeats forward and backward movements for several times, the left mirror 22 is kept at a position at which the image around the left rear wheel is produced since it is not possible to keep up with such movement if the mirror is driven each time.

The Case Where the Operation Object is the L/R Selector Switch 14

The L/R selector switch 14 as the operation object is a switch to switch an optical mirror device to be adjusted upon each push operation.

The control unit 16 determines the optical mirror device to be adjusted, based on the switch information S₃ acquired from the L/R selector switch 14 and the history information 160.

As a modification, the mirror control device 1 may be configured as a part of a mirror control system 6, as shown in FIG. 1C. The mirror control system 6 is generally composed of the touchpad 10 which is mounted on the vehicle 5 and detects an operation performed on the operation surface 100, the left optical mirror device 2 and the right optical mirror device 3 mounted on the vehicle 5, and the control unit 16 which controls the left optical mirror device 2 and the right optical mirror device 3 based on the operation detected by the touchpad 10 and adjusts an image around the vehicle 5 to be visually checked by an operator through the left optical mirror device 2 and the right optical mirror device 3.

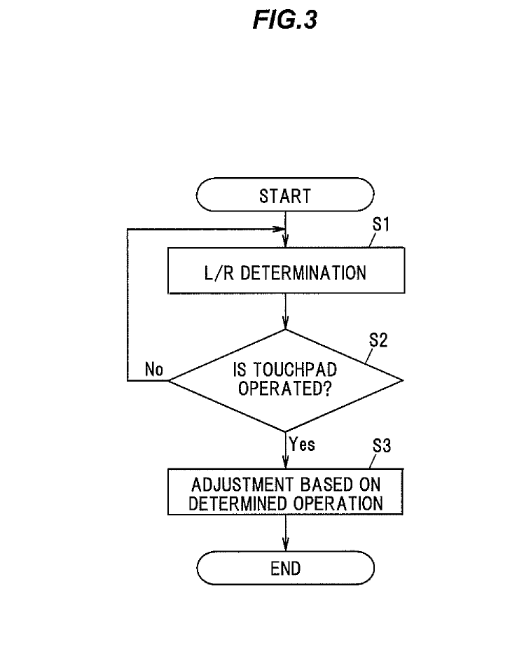

Next, an example operation of the mirror control device 1 in the first embodiment will be described in accordance with the flowchart of FIG. 3.

Operation

When the vehicle 5 is powered on, the control unit 16 of the mirror control device 1 acquires the touch information S₁ and the switch information S₃ and also checks the history information 160.

Next, based on the switch information S₃, the control unit 16 determines L/R, i.e., determines which of the left optical mirror device 2 and the right optical mirror device 3 is selected (S1).

Next, based on the touch information S₁, the control unit 16 determines whether or not an operation is performed. When the operation is performed (S2: Yes), the control unit 16 determines a type of the performed operation.

Next, the control unit 16 generates and outputs a drive signal corresponding to the type of the performed operation to the selected optical mirror device which is then adjusted based on the determined operation (S3). The selected optical mirror device moves the mirror according to the acquired drive signal.

Here, when any operation is detected in Step 2 (S2: No), the control unit 16 returns to Step 1 and determines L/R.

### Effects of the First Embodiment

The mirror control device 1 in the first embodiment is flexibly adaptable to mirror devices with different executable functions. In detail, the minor control device 1 in the first embodiment can adjust the positions of the mirrors of the optical mirror devices (the left optical mirror device 2 and the right optical mirror device 3) based on the operation performed on the touchpad 10, can move the mirrors back to the pre-adjustment positions based on the history information 160 and can also memorize the post-adjustment positions, without adding switches for such functions. The touchpad 10 can detect the tap operation and the pinch-in operation, etc., in addition to the swipe operation, the long press operation and the double click operation, and other functions can be assigned to these operations. Thus, the minor control device 1 can be flexibly adapted even when an object to be controlled is changed to a different optical mirror device.

The mirror control device 1 can drive the mirrors according to the swipe direction on the touchpad 10 and thus has better operability than when adjusting the mirrors to a desired angle by individually operating in the vertical and horizontal directions.

### Second Embodiment

The second embodiment is different from the other embodiments in that electronic mirror devices are controlled.

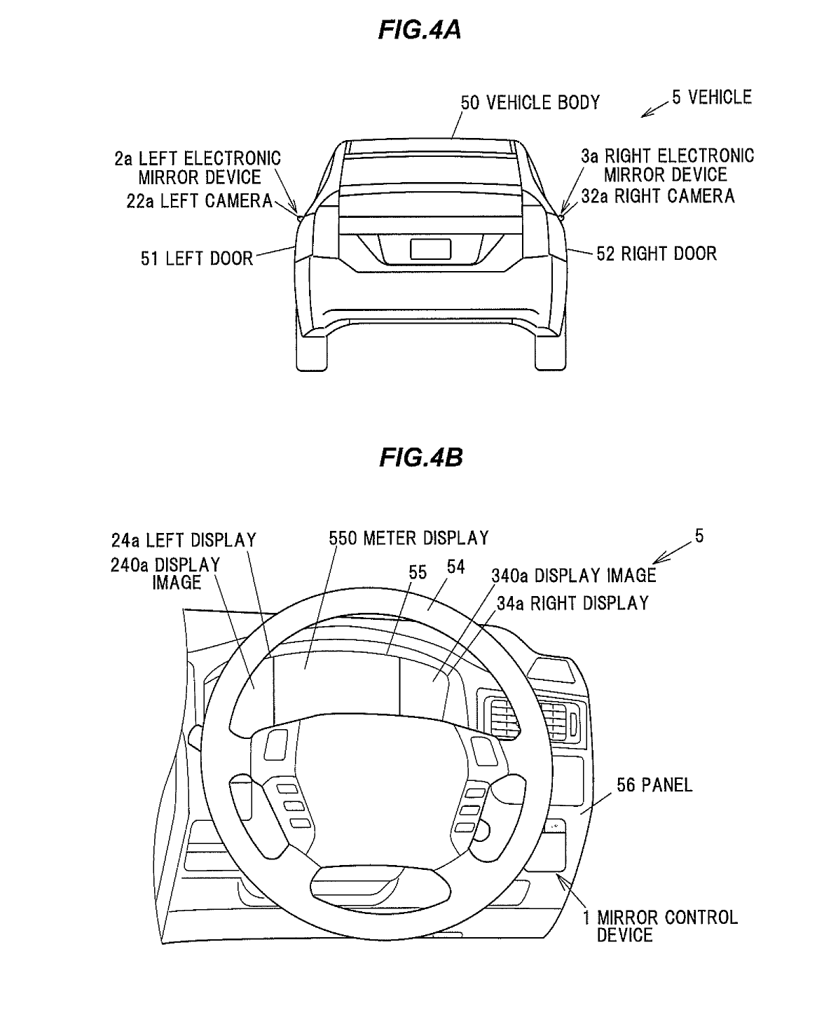

FIG. 4A is an illustration diagram showing a vehicle mounting a mirror control device in the second embodiment when viewed from the rear side of the vehicle and FIG. 4B is an illustration diagram showing a schematic view showing an example of a steering wheel area in which the mirror control device is arranged. FIG. 5A is a block diagram showing a configuration example of a mirror control system including the mirror control device in the second embodiment and FIG. 5B is an illustration diagram showing an example of a relation between operation objects and functions of the mirror control device. Outer mirrors are not provided on the vehicle 5 shown in FIG. 4A, but outer mirrors may be provided.

In the second embodiment, portions having the same functions and configurations as the first embodiment are denoted by the same reference numerals as the first embodiment and the explanation thereof will be omitted.

The mirror control device 1 in the second embodiment is configured to control electronic mirror devices. The electronic mirror device is to take an image of the rear view from a side of the vehicle 5 using a camera and to display the image on a display portion, and zoom-in/zoom-out, etc., of the image displayed on the display portion can be controlled by the mirror control device 1.

As shown in FIGS. 4A, 4B and 5A, the mirror control device 1 is generally composed of the touchpad 10 which is mounted on the vehicle 5 and detects an operation performed on the operation surface 100, and the control unit 16 which controls an left electronic mirror device 2a and an right electronic mirror device 3a as the electronic mirror devices mounted on the vehicle 5 based on the operation detected by the touchpad 10 and adjusts an image around the vehicle 5 to be visually checked by an operator through the left electronic mirror device 2a and the right electronic mirror device 3a.

Configuration of Left Electronic Mirror Device 2a and Right Electronic Mirror Device 3a

The left electronic mirror device 2a is generally composed of a left camera 22a as an imaging portion for taking an image around the vehicle 5, an image processor 23a for processing imaging information S₇ obtained based on the image taken by the left camera 22a, and a left display 24a as a display portion for displaying a display image 240a produced by processing the imaging information S₇.

The right electronic mirror device 3a is generally composed of a right camera 32a as an imaging portion for taking an image around the vehicle 5, an image processor 33a for processing imaging information S₁₀ obtained based on the image taken by the right camera 32a, and a right display 34a as a display portion for displaying a display image 340a produced by processing the imaging information S₁₀.

A drive unit 21a and a drive unit 31a are configured to drive, e.g., the left camera 22a and the right camera 32a in vertical and horizontal directions.

The left camera 22a and the right camera 32a are cameras based on, e.g., a solid-state image sensor such as CCD (Charge Coupled Device) image sensor or CMOS (complementary metal oxide semiconductor) image sensor. The left camera 22a is arranged on, e.g., the left door 51. The right camera 32a is arranged on, e.g., the right door 52. The left camera 22a and the right camera 32a may be configured to be capable of optical zoom under control of the control unit 16.

The image processor 23a processes, e.g., the imaging information S₇ acquired from the left camera 22a and generates display image information S₉ to be output to the left display 24a. The left display 24a produces and display the display image 240a based on the display image information S₉.

The image processor 23a processes the imaging information S₇ also according to an instruction based on, e.g., a control signal S₈ output from the control unit 16 and then generates the display image information S₉. This process according to the instruction is, e.g., zoom-in/zoom-out of the display image 240a displayed on the left display 24a.

The image processor 33a processes, e.g., the imaging information S₁₀ acquired from the right camera 32a and generates display image information S₁₂ to be output to the right display 34a. The right display 34a produces and display the display image 340a based on the display image information S₁₂.

The image processor 33a processes the imaging information S₁₀ also according to an instruction based on, e.g., a control signal S₁₁ output from the control unit 16 and then generates the display image information S₁₂. This process according to the instruction is, e.g., zoom-in/zoom-out of the display image 340a displayed on the right display 34a.

The left display 24a and the right display 34a are arranged on, e.g., a meter panel 55 so as to sandwich a meter display 550, as shown in FIG. 4B. The left display 24a, the right display 34a and the meter display 550 are, e.g., liquid-crystal displays. The meter display 550 displays, e.g., instruments such as speedometer.

Alternatively, the left display 24a and the right display 34a may be arranged on outer mirrors or may be arranged in a vehicle cabin so that an operator can visually check the images in the same manner as visually checking the outer mirrors. In addition, the vehicle 5 may be provided with both the optical mirror devices and the electronic mirror devices.

Functions Which Can Be Instructed By Mirror Control Device 1

The Case Where the Operation Object is the Touchpad 10

When the operation object is the touchpad 10, the mirror control device 1 executes different functions depending on the swipe operation, the long press operation, the double click operation, the pinch-in operation and the pinch-out operation, as shown in FIG. 5B.

When it is determined, based on the touch information S₁ acquired from the touchpad 10, that the swipe operation is performed, the control unit 16 moves a camera in the swipe direction. When it is determined that the swipe operation is performed from, e.g., left to right as viewed in the plane of FIG. 2A, the control unit 16 outputs the left drive signal S₄, when the left electronic mirror device 2a is selected, to rotate the left camera 22a counterclockwise in the horizontal direction, or the right drive signal S₅, when the right electronic mirror device 3a is selected, to rotate the right camera 32a counterclockwise in the horizontal direction.

Meanwhile, when the swipe operation is performed, e.g., from top to bottom as viewed in the plane of FIG. 2A, the control unit 16 outputs the left drive signal S₄, when the left electronic mirror device 2a is selected, to rotate the left camera 22a counterclockwise in the vertical direction, or the right drive signal S₅, when the right electronic mirror device 3a is selected, to rotate the right camera 32a clockwise in the vertical direction.

Furthermore, when the swipe operation is performed, e.g., diagonally as viewed in the plane of FIG. 2A, the control unit 16 resolves a trace of the swipe operation into a vertical component and a horizontal component and rotates the selected camera according to each component.

When the imaging area of the left camera 22a and the right camera 32a is sufficiently wide, the display image may be scrolled by image processing without moving the camera.

When it is determined, based on the touch information S₁, that the long press operation is performed, the control unit 16 moves the adjusted camera back to the pre-adjustment position (state). The control unit 16 controls the camera to move back to the pre-adjustment position based on, e.g., the history information 160.

In addition, when it is determined, based on the touch information S₁, that the double click operation is performed, the control unit 16 memorizes the camera position, which is an object to be adjusted, as the history information 160.

Furthermore, when it is determined, based on the touch information S₁, that the pinch-in operation is performed, the control unit 16 outputs a control signal to the image processer to zoom in the display image which is an object to be adjusted. For example, when the left electronic mirror device 2a is controlled, the control signal S₈ to zoom in the display image 240a is output from the control unit 16 to the image processor 23a. The image processor 23a generates the display image information S₉ associated with the display image 240a zoomed in based on the control signal S₈ and outputs the display image information S₉ to the left display 24a via the control unit 16. The zoom percentage depends on, e.g., a travel distance of the operating finger during the pinch-in operation.

Still further, when it is determined, based on the touch information S₁, that the pinch-out operation is performed, the control unit 16 outputs a control signal to the image processer to zoom out the display image which is an object to be adjusted. For example, when the left electronic mirror device 2a is controlled, the control signal S₈ to zoom out the display image 240a is output from the control unit 16 to the image processor 23a. The image processor 23a generates the display image information S₉ associated with the display image 240a zoomed out based on the control signal S₈ and outputs the display image information S₉ to the left display 24a via the control unit 16. The zoom percentage depends on, e.g., a travel distance of the operating finger during the pinch-out operation.

The Case Where the Operation Object is the Auto-Switch 12

When the auto-switch 12 is the operation object and is in the on state, the control unit 16 executes functions to move the cameras in conjunction with reverse or turning and a zoom function based on the vehicle information S₆ acquired from the vehicle 5.

In the motion in conjunction with reverse, when the control unit 16 determines based on the vehicle information S₆ that the vehicle 5 is moving backward, the control unit 16 moves the left camera 22a so that the left camera 22a can take the image around the left rear wheel which is hard to see from the operator's position. When it is determined that the backward movement is finished, the control unit 16 moves the left camera 22a back to the pre-movement position. Furthermore, when the operator repeats forward and backward movements for several times, the left camera 22a is kept at a position at which the image around the left rear wheel can be taken since it is not possible to keep up with such movement if the camera is driven each time.

The zoom function is a function to zoom in the display image to reduce burden of the operator when the speed of the vehicle 5 is faster than a predetermined level. The predetermined level is, e.g., not less than 80 km/h. As an example, when the mirror control device 1 determines, based on the vehicle information S₆, that the speed of the vehicle 5 is increased and the vehicle 5 is traveling along a highway, the zoomed-in display image 240a is displayed on the left display 24a.

The Case Where the Operation Object is the L/R Selector Switch 14

The L/R selector switch 14 as the operation object is a switch to switch an electronic mirror device to be adjusted upon each push operation.

The control unit 16 determines the electronic mirror device to be adjusted, based on the switch information S₃ acquired from the L/R selector switch 14 and the history information 160.

As a modification, the mirror control device 1 may be configured as a part of the mirror control system 6, as shown in FIG. 5A. The mirror control system 6 is generally composed of the touchpad 10 which is mounted on the vehicle 5 and detects an operation performed on the operation surface 100, the left electronic mirror device 2a and the right electronic minor device 3a mounted on the vehicle 5, and the control unit 16 which controls the left electronic mirror device 2a and the right electronic mirror device 3a based on the operation detected by the touchpad 10 and adjusts an image around the vehicle 5 to be visually checked by an operator through the left electronic mirror device 2a and the right electronic mirror device 3a. In this case, the operator visually checks the image around the vehicle 5 through the left display 24a of the left electronic mirror device 2a and the right display 34a of the right electronic mirror device 3a.

Next, an example operation of the mirror control device 1 in the second embodiment will be described in accordance with the flowchart of FIG. 3.

Operation

When the vehicle 5 is powered on, the control unit 16 of the mirror control device 1 acquires the touch information S₁ and the switch information S₃ and also checks the history information 160.

Next, based on the switch information S₃, the control unit 16 determines which of the left electronic mirror device 2a and the right electronic mirror device 3a is selected (S1).

Next, based on the touch information S₁, the control unit 16 determines whether or not an operation is performed. When the operation is performed (S2: Yes), the control unit 16 determines a type of the performed operation.

Next, the control unit 16 generates and outputs a drive signal or a control signal corresponding to the type of the performed operation to the selected electronic mirror device which is then adjusted based on the determined operation (S3). The selected electronic mirror device moves the camera according to the acquired drive signal or performs zoom-in or zoom-out of the display image according to the acquired control signal.

Here, when any operation is detected in Step 2 (S2: No), the control unit 16 returns to Step 1 and determines L/R.

### Effects of the Second Embodiment

The mirror control device 1 in the second embodiment is flexibly adaptable to mirror devices with different executable functions. In detail, the mirror control device 1 in the second embodiment can instruct the positions of the cameras of the electronic mirror devices (the left electronic mirror device 2a and the right electronic mirror device 3a) and zoom-in or zoom-out of the display image based on the operation performed on the touchpad 10, can move the cameras back to the pre-adjustment positions based on the history information 160 and also can memorize the post-adjustment positions, without adding switches for such functions. The controlled object is an optical mirror device in the first embodiment but is an electronic mirror device in the second embodiment. As such, the mirror control device 1 can be flexibly adapted even when an object to be controlled is changed from the optical mirror device to the electronic mirror device.

The mirror control device 1 can drive the cameras according to the swipe direction on the touchpad 10 and thus has better operability than when adjusting the cameras to a desired angle by individually operating in the vertical and horizontal directions.

The mirror control device 1 can easily perform zoom-in and zoom-out of the display image by an pinch-in operation and a pinch-out operation, which cannot be realized by the optical mirror device. Therefore, visibility and operability are good.

As a modification, when the vehicle 5 has a camera at a position allowing the image of the rear side of the vehicle 5 to be taken, such as a trunk lid, and is configured that the image taken by the camera is displayed on a rear-view mirror in a vehicle cabin, the mirror control device 1 may be configured to control such a camera.

The mirror control device 1 and the mirror control system 6 in the embodiments and the modifications may be partially realized by a computer executable program, ASIC (Application Specific Integrated Circuit) and FPGA (Field Programmable Gate Array), etc., depending on the intended use.

Although some embodiments and modifications of the invention have been described above, the embodiments and modifications are merely an example and the invention according to claims is not to be limited thereto. These new embodiments and modifications may be implemented in various other forms, and various omissions, substitutions and changes, etc., can be made without departing from the gist of the invention. In addition, all combinations of the features described in the embodiments and modifications are not necessary to solve the problem of the invention. Further, these embodiments and modifications are included within the scope and gist of the invention and also within the invention described in the claims and the equivalency thereof.

What is claimed is:

1. A mirror control device, comprising:
a touchpad that is mounted on a vehicle and detects an operation performed on an operation surface; and
a control unit that controls at least one of an optical mirror device and an electronic mirror device mounted on the vehicle based on an operation detected by the touchpad and adjusts an image around the vehicle to be visually checked by an operator through the optical mirror device and/or the electronic mirror device.

2. A mirror control system, comprising:
a touchpad that is mounted on a vehicle and detects an operation performed on an operation surface;
at least one of an optical mirror device and an electronic mirror device mounted on the vehicle; and
a control unit that controls the optical mirror device and/or the electronic mirror device based on an operation detected by the touchpad and adjusts an image around the vehicle to be visually checked by an operator through the optical mirror device and/or the electronic mirror device.

3. The mirror control device according to claim 1, wherein the electronic mirror device comprises an imaging portion for taking an image around the vehicle, an image processor for processing image information obtained based on the image taken by the imaging portion, and a display portion for displaying a display image produced by processing the imaging information, and
wherein the control unit controls the electronic mirror device and implements at least one of zoom-in, zoom-out of the display image and a change of the displayed area.

4. The mirror control device according to claim 1, wherein the control unit generates and stores history information as a history of adjustment, retrieves the history information based on a predetermined operation performed on the touchpad and restores the pre-adjustment state.

5. The mirror control system according to claim 2, wherein the electronic mirror device comprises an imaging portion for taking an image around the vehicle, an image processor for processing image information obtained based on the image taken by the imaging portion, and a display portion for displaying a display image produced by processing the imaging information, and
wherein the control unit controls the electronic mirror device and implements at least one of zoom-in, zoom-out of the display image and a change of the displayed area.

6. The mirror control system according to claim 2, wherein the control unit generates and stores history information as a history of adjustment, retrieves the history information based on a predetermined operation performed on the touchpad and restores the pre-adjustment state.

7. The mirror control device according to claim 1, further comprising a switch for selecting a left mirror or a right mirror in the optical mirror device or the electronic mirror device.

8. The mirror control device according to claim 1, wherein the touchpad that allows a swipe operation to request a rotation in a vertical direction or in a horizontal direction of the left mirror or the right mirror selected by the switch such that the left mirror or the right mirror rotates according to a direction and a distance of a trace of the swipe operation.
